(19) United States
(12) Patent Application Publication
(10) Pub. No.: US 2025/0178433 A1
(43) Pub. Date: Jun. 5, 2025

(54) AUXILLIARY FUEL TANK

(71) Applicant: Todd Zuccone, Phoenix, AZ (US)

(72) Inventor: Todd Zuccone, Phoenix, AZ (US)

(21) Appl. No.: 18/967,961

(22) Filed: Dec. 4, 2024

Related U.S. Application Data
(60) Provisional application No. 63/605,607, filed on Dec. 4, 2023.

(51) Int. Cl. B60K 15/067; B60K 15/04

(52) U.S. Cl. CPC B60K 15/067; B60K 15/0406; B60K 2015/0438

(57) ABSTRACT

An auxiliary fuel tank for off-road vehicles is provided. The auxiliary fuel tank may include a top wall, multiple angled front and side walls and a bottom wall. Securement tabs with apertures are provided on the bottom wall and the top wall for securing the auxiliary fuel tank within an upright receptacle, such as a passenger side glove box.

### CROSS REFERENCE TO RELATED APPLICATION(S)

This application claims priority to U.S. Provisional Patent Application entitled “AUXILLIARY FUEL TANK,” Ser. No. 63/605,607, filed Dec. 4, 2023, the disclosure of which is hereby incorporated entirely herein by reference.

### BACKGROUND OF THE INVENTION

### Technical Field

This invention relates generally to an auxiliary fuel tank, and more particularly to an auxiliary fuel tank for an off-road vehicle.

### State of the Art

Off-road vehicles, such as all terrain vehicles (ATVs) and utility terrain vehicles (UTVs) are becoming more and more prevalent in the ownership, use, racing and so forth. Particularly, UTVs are the typical off-road vehicle type that people purchase and utilize. UTVs and other off-road vehicles are often used in areas with limited opportunity to refuel. Increasing fuel capacity would allow for longer rides and increased utility.

Accordingly, there is a need in the industry for auxiliary fuel tanks to increase the range of off-road vehicles.

### SUMMARY OF THE INVENTION

An embodiment includes an auxiliary fuel tank for an off-road vehicle comprising a top wall; a plurality of front and side walls; a bottom wall; first and second securement tab members provided on the bottom wall, each having at least one aperture therein; third and fourth securement tab members extending from the top wall, each having at least one clamp extending therefrom; and a threaded inlet tube provided in the top wall for receiving an auxiliary fuel tank cap.

Another embodiment includes an auxiliary fuel tank for an off-road vehicle comprising: first and second securement tab members extending from a bottom portion of the auxiliary fuel tank, each having at least one aperture therein; third and fourth securement tab members extending from a top wall of the auxiliary fuel tank, each having at least one clamp extending therefrom; and a threaded inlet tube provided in the top wall for receiving an auxiliary fuel tank cap.

Another embodiment includes a method of using an auxiliary fuel tank with an off-road vehicle, the method comprising: removing a passenger side glove box of the off-road vehicle; coupling the auxiliary fuel tank to the off-road in an opening left from removing the passenger side glove box; and fluidly coupling the auxiliary fuel tank to a main fuel tank of the off-road vehicle.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a frontal perspective view of an auxiliary fuel tank in accordance with an embodiment of the present invention;

FIG. 2 is a rearward perspective view of an auxiliary fuel tank in accordance with an embodiment of the present invention;

FIG. 3 is a bottom perspective view of an auxiliary fuel tank in accordance with an embodiment of the present invention;

FIG. 4 is a perspective view of an off-road vehicle having a passenger side glove box in accordance with an embodiment of the present invention;

FIG. 5 is a partial perspective view of an auxiliary fuel tank in accordance with an embodiment of the present invention;

FIG. 6 is a partial perspective view of an auxiliary fuel tank secured to a rod member in accordance with an embodiment of the present invention;

FIG. 7 is a partial bottom perspective view of an auxiliary fuel tank secured to an inner wall in accordance with an embodiment of the present invention; and

FIG. 8 is a frontal perspective view of an auxiliary fuel tank in accordance with an embodiment of the present invention.

### DETAILED DESCRIPTION OF EMBODIMENTS OF THE INVENTION

As discussed above, embodiments of the present invention relate to an auxiliary fuel tank for an off-road vehicle.

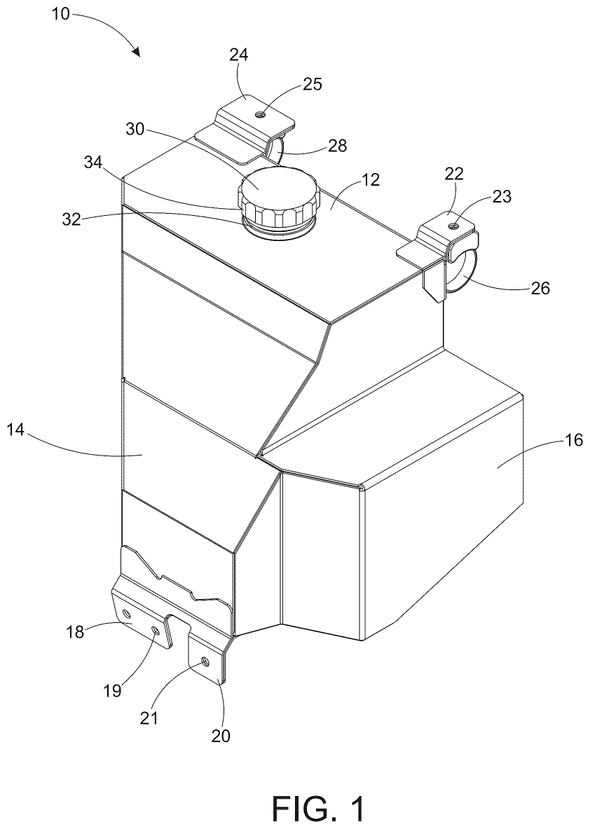

Referring to the drawings, FIGS. 1-3 depict an auxiliary fuel tank 10 in accordance with an embodiment of the present invention. The auxiliary fuel tank 10 comprises a top wall 12, a plurality of angled front walls 14 and a first plurality of angled sidewalls 16. A first securement tab member 18 having at least one aperture 19 for receiving a fastener (not shown) therein and a second securement tab member 20 having at least one aperture 21 for receiving a fastener (not shown) therein extending from a lower portion of auxiliary fuel tank 10. A third securement tab member 22 is provided on top wall 12. The third securement tab member 22 may have a first circular securement clamp 26 extending therefrom and at least one aperture 23 for receiving a fastener (not shown). A fourth securement tab member 24 is also provided on top wall 12. The fourth securement tab member 24 may have a second circular securement clamp 28 extending therefrom and at least one aperture 25 for receiving a fastener (not shown). The top wall 12 is provided with a fuel tank cap 30 with a plurality of gripping projections 34 provided about an outer periphery thereof. Fuel tank cap 30 is threadingly engaged with a threaded inlet tube 32, or may be otherwise coupled to the inlet tube 32.

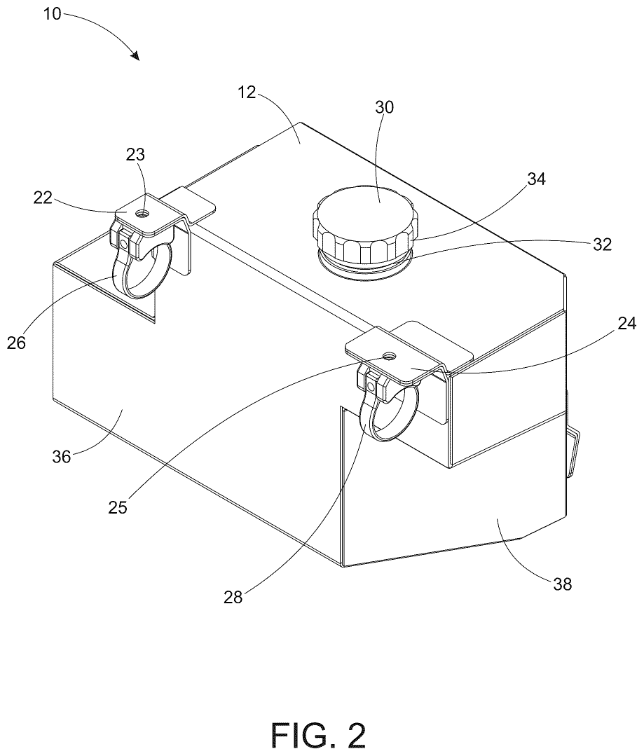

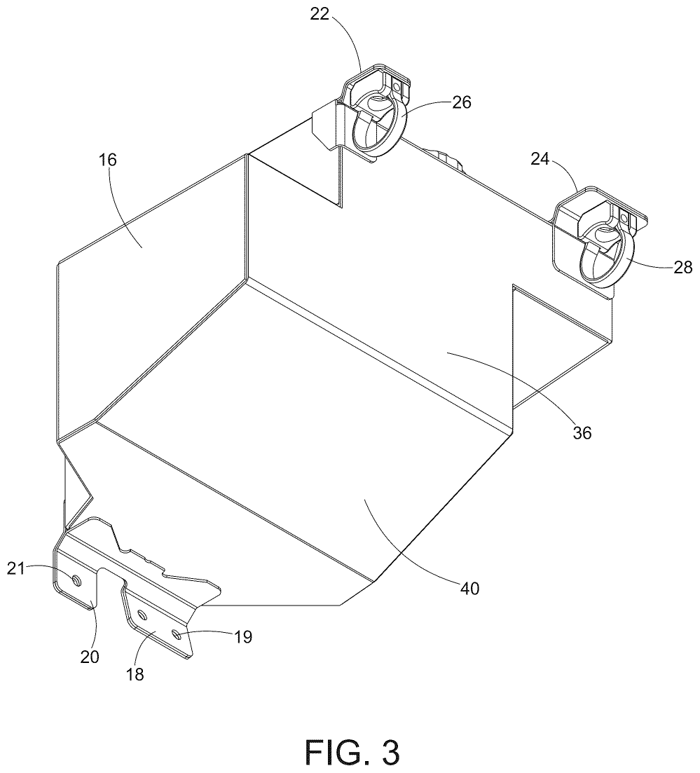

In FIG. 2 a planar rear wall 36 having multiple planar sections is provided between the top wall 12, the first plurality of angled sidewalls 16 (See FIG. 1) and a second plurality of angled sidewalls 38. In FIGS. 2-3 a plurality of angled bottom walls 40 is provided between the first plurality of angled sidewalls 16, the planar rear wall 36 and the second plurality of angled sidewalls 38.

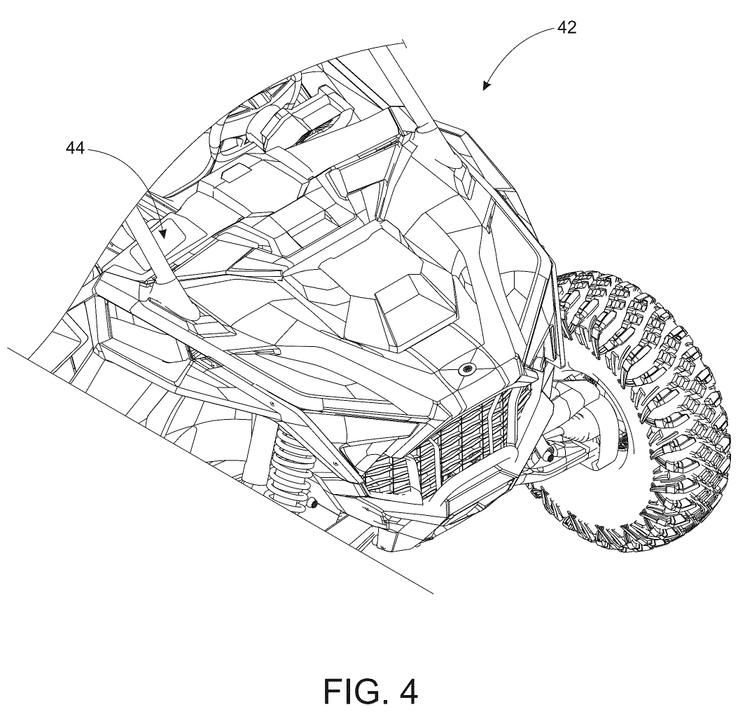

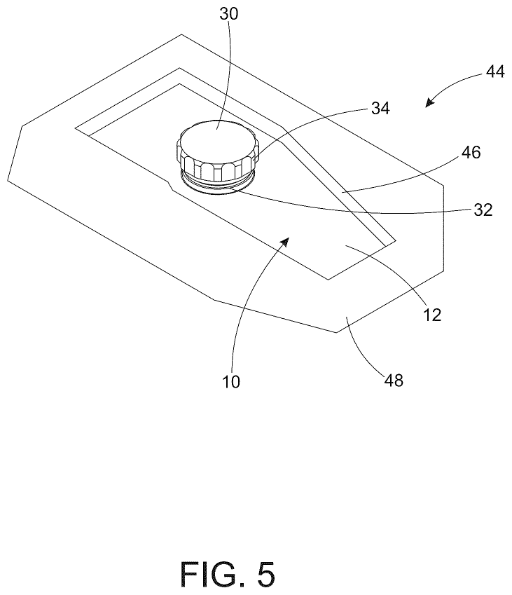

FIG. 4 shows a partial view of an off-road vehicle 42 provided with a passenger side glove box 44. In FIG. 5, passenger side glove box 44 provides an upright receptacle area 46 for receiving the auxiliary fuel tank 10. The upright receptacle area 46 enables access to the threaded inlet tube 32 having fuel tank cap 30.

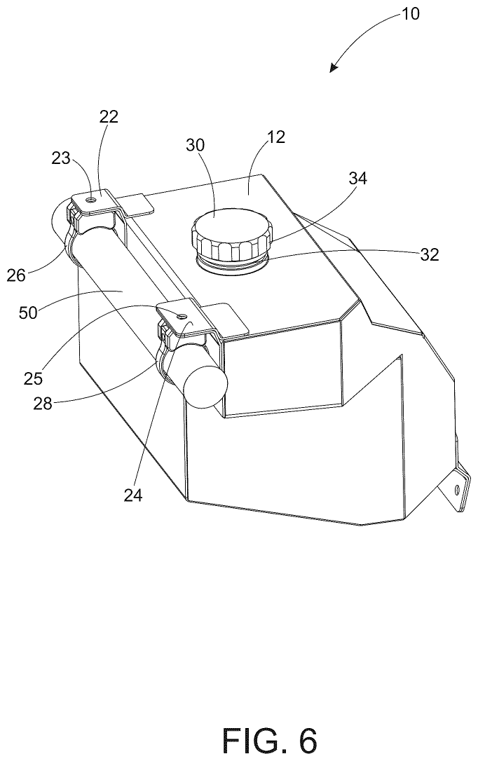

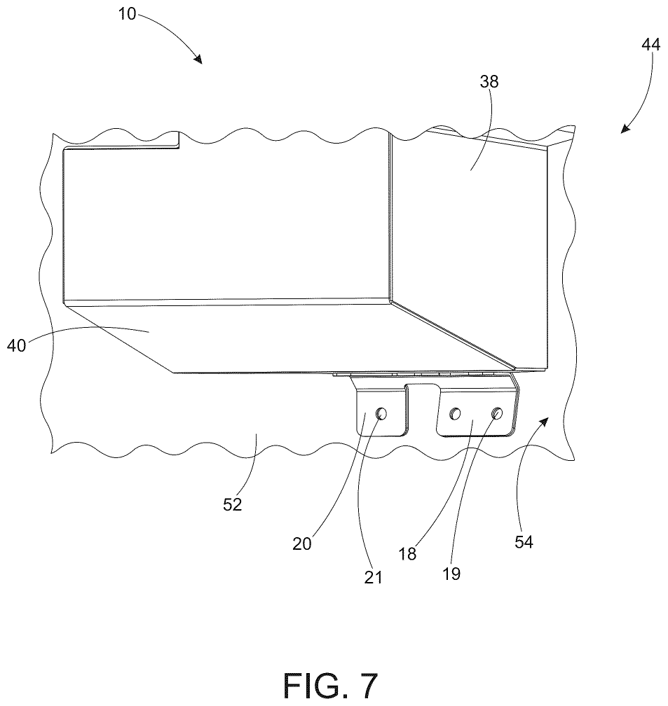

FIG. 6 shows auxiliary fuel tank 10 mounted to a rod member 50 via first and second circular securement clamps 26 and 28 provided on the third and fourth securement tab members 22 and 24. The third and fourth securement tab members 22 and 24 are rigidly secured to the top wall 12 of the auxiliary fuel tank 10. FIG. 7 shows first and second securement tab members 18 and 20 extending downward from at least one of the plurality of angled bottom walls 40. The first and second securement tab members 18 and 20 are secured to a front inner wall 52 of a cabin 54 of the off-road vehicle 44.

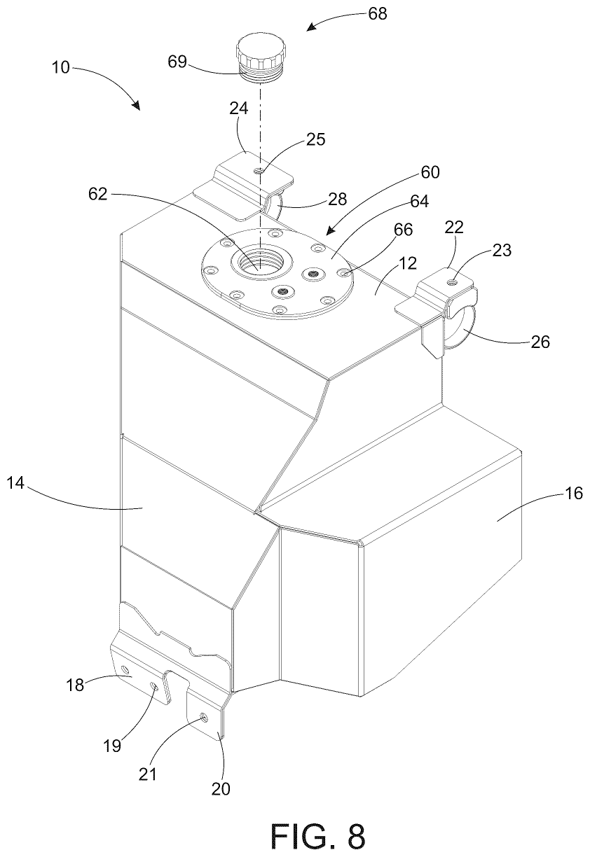

FIG. 8 shows an alternative embodiment of fuel tank inlet 60 having an inwardly extending threaded inlet tube 62 having a peripheral planar flange portion 64 extending thereabout. Peripheral planar flange portion 64 is fixedly secured to top wall 12 with at least one fastener (not shown) provided within at least one aperture 66. A fuel tank plug member 68 having a threaded plug portion 69 is threadingly received within inwardly extending threaded inlet tube 62.

The volume of the auxiliary fuel tank of the present invention may be in the range of about 4.6 to about 7 gallons. The auxiliary fuel tank may replace an original equipment manufacturer (OEM) passenger side glove box. The auxiliary fuel tank may be installed from below through an opening left by removing the passenger side glove box. The auxiliary fuel tank may bolt in place with two subframe clamps, for example, provided on a top wall and through tabs, such as doubler plates, provided on a bottom wall and secured to a fire wall.

The auxiliary fuel tank of the present invention may employ an internal fuel pump to transfer fuel from the auxiliary fuel tank to a main fuel tank with a fuel hose. The fuel hose may be plumbed into an OEM fuel filler hose with, for example, an aluminum coupler having a pair of fittings. One fitting may be attached to the fuel hose and the other fitting may be attached to an auxiliary fuel tank vent/overflow. The internal fuel pump may be controlled by a manual rocker on/off switch.

Fuel transfer between the auxiliary fuel tank of the present invention and the main fuel tank may be automated to eliminate the ability to overfill the main fuel tank. The user may also manually turn on/off the internal fuel pump of the auxiliary fuel tank, whereby the user may begin transferring fuel whether or not the main fuel tank is low enough to accept it.

A voltage signal from an OEM fuel sending unit may be used with the auxiliary fuel tank of the present invention. A printed circuit board (PCB) may detect and use the voltage signal to automatically trigger a relay to provide current (12 v) to the internal fuel pump of the auxiliary fuel tank at a pre-determined voltage level from the OEM fuel sending unit. The PCB may be provided with different predetermined settings for various size auxiliary fuel tanks.

For example, on a 12 gallon main fuel tank (1 gallon reserve) with a 7 gallon auxiliary fuel tank, the main fuel tank would have to be below 4 gallons to accept a full transfer from the auxiliary fuel tank. When the signal voltage from the OEM fuel sending unit reaches a threshold at or below 4 gallons, a signal would trigger the PCB and power would be sent to the internal fuel pump of the auxiliary fuel tank. When the voltage from the OEM fuel sending unit reaches a full position voltage, a signal would trigger the PCB to turn off the internal fuel pump of the auxiliary fuel tank.

Other safety triggers which may be part of the PCB include a manual on/off switch to arm a relay system/PCB. The manual on/off switch controls the PCB/relay system in order to receive the voltage signal from the OEM fuel sending unit and triggers both on/off at set voltages from the OEM fuel sending unit. An additional timer may be provided to automatically turn off the internal fuel pump of the auxiliary fuel tank in case the auxiliary fuel tank is not full of fuel or only partially full. An over-ride mode may be also provided allowing the user to override predetermined settings and trigger the internal fuel pump of the auxiliary fuel tank in a manual mode.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. An auxiliary fuel tank for an off-road vehicle comprising:
a top wall;
a plurality of front and side walls;
a bottom wall;
first and second securement tab members provided on the bottom wall, each having at least one aperture therein;
third and fourth securement tab members extending from the top wall, each having at least one clamp extending therefrom; and
a threaded inlet tube provided in the top wall for receiving an auxiliary fuel tank cap.

2. The auxiliary fuel tank of claim 1, wherein the at least one clamp extending from the third and fourth securement tab members are configured to couple to a rod member of the off-road vehicle.

3. The auxiliary fuel tank of claim 1, wherein the first and second securement tab members are configured to couple to the off-road vehicle through the at least one aperture of the first and second securement tab members.

4. The auxiliary fuel tank of claim 1, further comprising a fuel tank inlet coupled to the top wall.

5. The auxiliary fuel tank of claim 4, wherein the fuel tank inlet comprises the threaded inlet tube extending inwardly into the fuel tank and a peripheral planar flange portion extending thereabout.

6. The auxiliary fuel tank of claim 5, wherein the peripheral planar flange portion is fixedly secured to the top wall.

7. An auxiliary fuel tank for an off-road vehicle comprising:
first and second securement tab members extending from a bottom portion of the auxiliary fuel tank, each having at least one aperture therein; third and fourth securement tab members extending from a top wall of the auxiliary fuel tank, each having at least one clamp extending therefrom; and
a threaded inlet tube provided in the top wall for receiving an auxiliary fuel tank cap.

8. The auxiliary fuel tank of claim 7, wherein the at least one clamp extending from the third and fourth securement tab members are configured to couple to a rod member of the off-road vehicle.

9. The auxiliary fuel tank of claim 7, wherein the first and second securement tab members are configured to couple to the off-road vehicle through the at least one aperture of the first and second securement tab members.

10. The auxiliary fuel tank of claim 7, further comprising a fuel tank inlet coupled to the top wall.

11. The auxiliary fuel tank of claim 10, wherein the fuel tank inlet comprises the threaded inlet tube extending inwardly into the fuel tank and a peripheral planar flange portion extending thereabout.

12. The auxiliary fuel tank of claim 11, wherein the peripheral planar flange portion is fixedly secured to the top wall.

13. A method of using an auxiliary fuel tank with an off-road vehicle, the method comprising:
removing a passenger side glove box of the off-road vehicle;
coupling the auxiliary fuel tank to the off-road in an opening left from removing the passenger side glove box; and
fluidly coupling the auxiliary fuel tank to a main fuel tank of the off-road vehicle.

14. The method of claim 13, wherein the auxiliary fuel tank comprises:
first and second securement tab members extending from a bottom portion of the auxiliary fuel tank, each having at least one aperture therein;
third and fourth securement tab members extending from a top wall of the auxiliary fuel tank, each having at least one clamp extending therefrom; and a threaded inlet tube provided in the top wall for receiving an auxiliary fuel tank cap.

15. The method of claim 14, wherein coupling the auxiliary fuel tank to the off-road in the opening left from removing the passenger side glove box comprises coupling the at least one clamp extending from the third and fourth securement tab members to a rod member of the off-road vehicle.

16. The method of claim 14, wherein coupling the auxiliary fuel tank to the off-road in the opening left from removing the passenger side glove box comprises coupling the first and second securement tab members to the off-road vehicle through the at least one aperture of the first and second securement tab members.

17. The method of claim 13, further comprising pumping fuel from the auxiliary fuel tank to the main fuel tank.

18. The method of claim 17, wherein pumping the fuel from the auxiliary fuel tank to the main fuel tank comprises automatically operating a pump when a fuel level in the main fuel tank reaches a predetermined threshold.

19. The method of claim 17, wherein pumping the fuel from the auxiliary fuel tank to the main fuel tank comprises manually engaging a switch to operate a pump.
